(19) United States
(12) Patent Application Publication
(10) Pub. No.: US 2007/0048600 A1
(43) Pub. Date: Mar. 1, 2007

(54) Cell holder, fuel cell module and electronic equipment

(76) Inventor: Ryuji Kohno, Kasumigaura (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/356,211

(22) Filed: Feb. 17, 2006

(30) Foreign Application Priority Data
Aug. 26, 2005 (JP) 2005-245798

(51) Int. Cl. H01M 2/10

(52) U.S. Cl. 429/99; 429/100

(57) ABSTRACT

An object of the present invention is to provide a cell holder for electrically connecting a plurality of MEAs in parallel or in series without mounting, e.g., lead wires to current collectors. The cell holder includes terminals which are in contact with and electrically connected to contact portions of anodes and cathodes of a plurality of power units having MEAs. The plurality of power units are integrated with each other in the fuel cell holder when the fuel cell module is mounted on the cell holder. In addition, the cell holder includes a connecting portion for electrically connecting a terminal corresponding to a contact portion of an anode of one of the power unit and a terminal corresponding to a contact portion of a cathode of the other power unit.

### CLAIM OF PRIORITY

The present application claims priority from Japanese application serial JP 2005-245798 filed on Aug. 26, 2005, the content of which is hereby incorporated by reference into this application.

### FIELD OF THE INVENTION

The present invention relates to a cell holder, a fuel cell module, and electronic equipment.

### BACKGROUND OF THE INVENTION

As power source for mobile terminals and notebook personal computers, fuel cells are under development. The fuel cells in general include fuel electrodes, air electrodes, and MEAs (Membrane Electrode Assemblies) including electrolyte membranes sandwiched between the fuel electrodes and air electrodes. Additionally, the fuel cells include current collectors sandwiching the MEAs (for example, see the patent document 1).

Conventionally, in accordance with, e.g., a rated voltage of electronic equipment, when a plurality of MEAs are arranged in series or in parallel, each of both ends of an electrical conductor such as a lead wire are attached to current collectors of different MEAs to electrically connect a plurality of the MEAs to each other. The plurality of the MEAs electrically connected in series or in parallel are integrated with each other to be one battery pack. The battery pack is mounted on a cell holder of the electronic equipment.

[Patent document 1]

JP-1997-092323A (Paragraph numbers 0014 to 0017)

However, the electrical conductor such as the lead wire is attached to the current collectors to connect a plurality of the MEAs in series or in parallel by, e.g., screws or welding. Therefore, the attachment takes a long time and a lot of effort.

In view of the above problem, the present invention is achieved. An object of the present invention is to provide a cell holder in which a plurality of MEAs can be connected in series or in parallel without using, e.g., lead wires, a fuel cell module mounted on the cell holder, and electronic equipment including the cell holder.

### SUMMARY OF THE INVENTION

As means for solving the problem, a cell holder of the present invention, on which a fuel cell module is mounted, the fuel cell module including a plurality of power units having membrane electrode assemblies generating electrical power by use of liquid fuel, and a case for integrating these power units with each other. In the fuel cell module, at least a part of each of anodes and cathodes of all the power units is a contact portion for electrical connection from outside the case for integrating the plurality of the power units with each other. The cell holder includes terminals corresponding to the number of the anodes and cathodes of the power units. The terminals come in contact with and are electrically connected to the contact portions of the anodes and cathodes when the fuel cell module is mounted on the cell holder. In addition, the cell holder includes a connecting portion for electrically connecting the terminal corresponding to the contact portion of the anode of one of the power units and the terminal corresponding to the contact portion of the cathode of the other power unit.

In the cell holder, the terminals of the cell holder come in contact with and electrically connected to the anode of one power unit of the fuel cell module and the cathode of the other power unit of the fuel cell module when the fuel cell module is mounted on the cell holder. Accordingly, MEAs of a plurality of the power units can be electrically connected in series through the terminals and the connecting portion.

The fuel cell module of the present invention is mounted on the cell holder. The fuel cell module is electrically connected to the terminals of the cell holder. The fuel cell module includes a plurality of the power units having membrane electrode assemblies generating electrical power by use of liquid fuel, and the case for integrating these power units with each other. The anodes and cathodes of the power units have the contact portions in contact with and electrically connected to the terminals when the fuel cell module is mounted on the cell holder.

The fuel cell module is mounted on the cell holder, so that the anodes and cathodes of the power units can be electrically connected to each other.

According to the present invention, a plurality of the MEAs does not need to be electrically connected to each other in the fuel cell module. The fuel cell module is mounted on the cell holder, so that the MEAs in the fuel cell module can be electrically connected to each other. Accordingly, the attachment of electrical conductors is unnecessary for electrically connecting the MEAs to each other. The time and effort for production of the fuel cell module can be decreased, and a cost for the production can be reduced. Additionally, a space for the electrical conductors in the fuel cell module is unnecessary. Thus, the fuel cell module can be made smaller.

### BRIEF DESCRIPTION OF THE DRAWINGS

FIG. 1 is a plane view of a cell holder on which a fuel cell module of the present embodiment is mounted.

FIG. 2 is a perspective view of the fuel cell module of the present embodiment.

FIG. 3 is a partial breakaway view of the fuel cell module of the present embodiment.

FIG. 4 is an exploded perspective view of the fuel cell module of the present embodiment.

FIG. 5 is a cross section of the fuel cell module of the present embodiment, the cross section being along an X-X line shown in FIG. 2.

FIG. 6 is an overall perspective view of a notebook personal computer including the cell holder of the present embodiment.

FIG. 7A is an explanatory schematic view schematically showing another embodiment of a terminal of the cell holder of the present embodiment.

FIG. 7B is an explanatory schematic view schematically showing a part of a fuel cell module in which elastic portions are provide to rear surfaces of contact portions.

FIG. 8 is an exploded perspective view of another embodiment of the fuel cell module of the present embodiment.

FIG. 9 is an exploded perspective view of a fuel cell module of an alternative of the present embodiment.

### DETAILED DESCRIPTION OF THE PREFERRED EMBODIMENTS

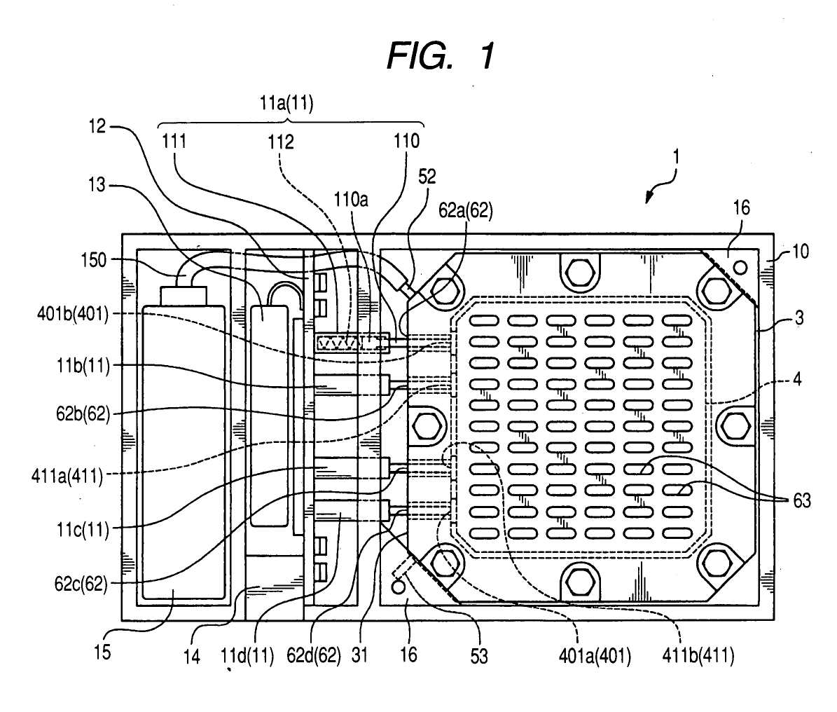

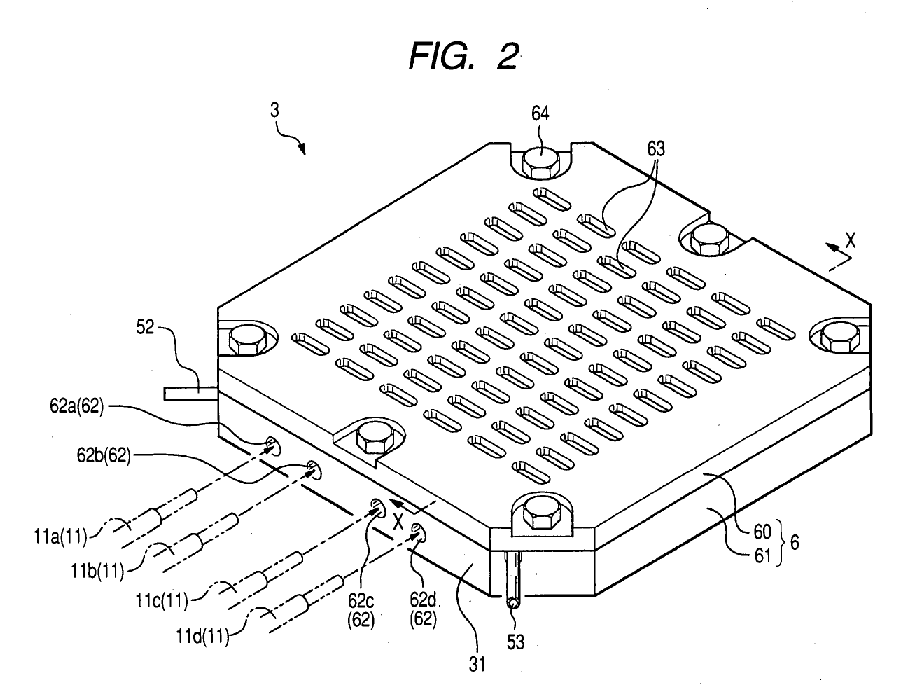

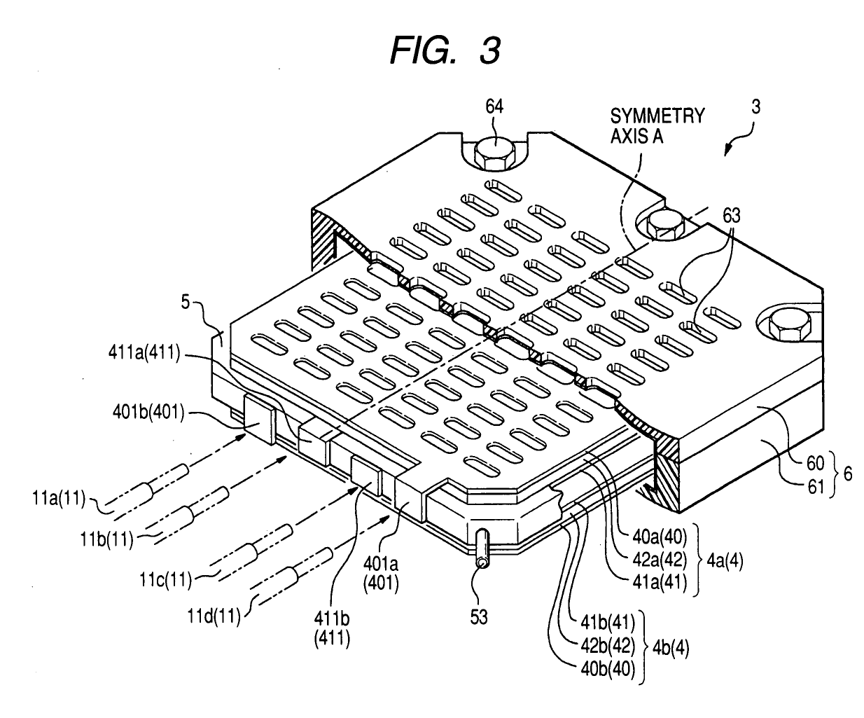

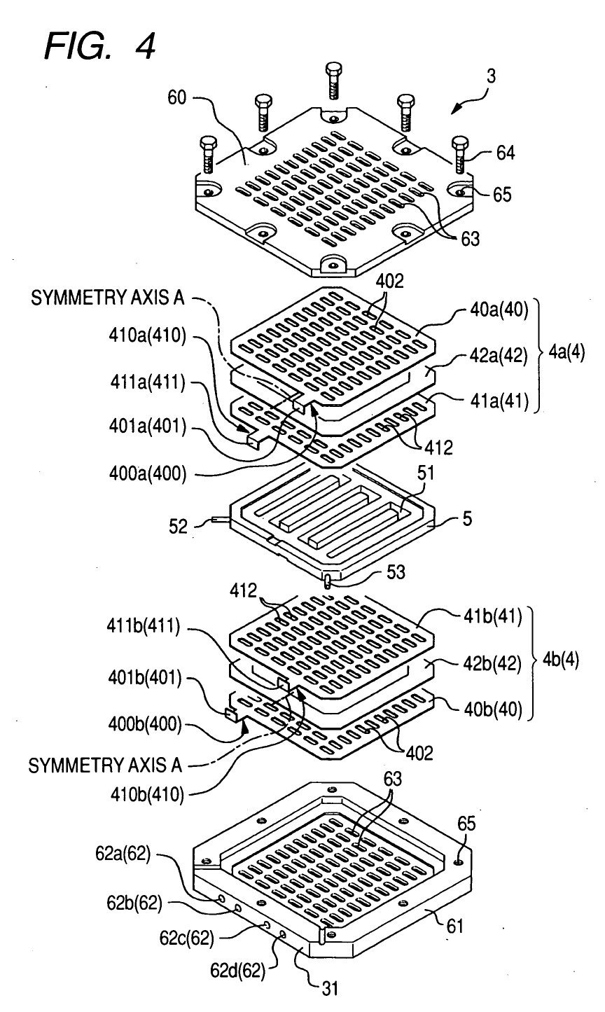

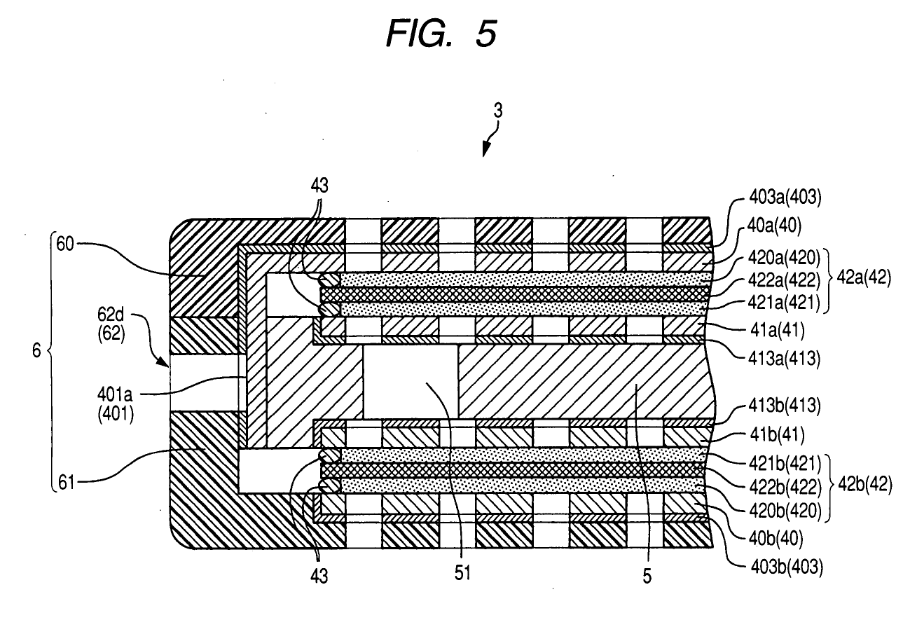

Embodiments of the present invention are explained below in reference to the drawings. FIG. 1 is a plane view of a cell holder on which a fuel cell module of this embodiment is mounted. FIG. 2 is a perspective view of the fuel cell module of this embodiment. FIG. 3 is a partial breakaway view of the fuel cell module of this embodiment. FIG. 4 is an exploded perspective view of the fuel cell module of this embodiment. FIG. 5 is a cross section along an X-X line shown in FIG. 5.

A case where a fuel cell module 3 is a direct methanol fuel cell (DMFC) is explained here. A case where the fuel cell module 3 includes two power units 4a, 4b (see FIG. 4) is explained here. The fuel cell module 3 may include a plurality of the power units 4.

[Structure of the Cell Holder]

As shown in FIG. 1, the cell holder 1, on which the fuel cell module 3 is mounted, is electrically connected to the fuel cell module 3. The cell holder 1 electrically connects a plurality of the power units 4 to each other in the fuel cell module 3. The cell holder 1 includes a body 10, terminals 11 (11a, 11b, 11c, 11d), a control substrate 12, an electric double layer capacitor 13, a USB connector 14, a fuel cartridge 15, and detachment preventing means 16.

The fuel cell module 3 is detachably mounted on the body 10. The body 10 is a container containing the terminals 11, the control substrate 12, the electric double layer capacitor 13, the USB connector 14, and the fuel cartridge 15. For example, the body 10 is made of plastic. A bottom plate (not shown) of the body 10 has a plurality of air flow holes (not shown). The bottom plate is in contact with a bottom surface (not shown) of the fuel cell module 3. Air can be supplied toward the bottom surface of the fuel cell module 3.

The terminals 11 are in contact with cathode current collectors 40 and anode current collectors 41 (after-mentioned, see FIG. 3) of the power units 4 in the fuel cell module 3. Thus, the terminals 11 electrically connect the fuel cell module 3 and control substrate 12. As shown in FIGS. 2, 3, top ends of the terminals 11 are inserted into openings 62 to be in contact with the cathode current collectors 40 and anode current collectors 41 of the power units 4. As shown in FIG. 1, the other ends of the terminals 11 are fixed to, and electrically connected to the control substrate 12, and fixed to the body 10. The terminals 11 are spring probes including plungers 110, barrels 111, and springs 112.

Top ends of the plungers (contacting portions of the cell holder) 110 are in contact with contact portions 401 (of the fuel cell module, see FIG. 3) of the cathode current collectors 40 of the power units 4 and with contact portions 411 (of the fuel cell module, see FIG. 3) of the anode current collectors 41 of the power units 4. Additionally, the top ends of the plungers 110 are in contact with hollow insides of the barrels 111, so that the power units 4 and the barrels 111 are in electrical contact with each other. The springs 112 bias the plungers 110 in such a direction that the plungers 110 are pressed against the contact portions 401, 411. Accordingly, the plungers 110 can be in electrical communication with the cathode current collectors 40 and anode current collectors 41 certainly. The top ends of the plungers 110 penetrate the openings 62 provided to a side surface 31 (see FIG. 2) of the fuel cell module 3 to be in contact with the contact portions 401 and 411.

The springs 112 and body portions 110a of the plungers 110 are inserted into the hollow insides of the barrels 111, respectively. Rear ends of the barrels 111 are electrically connected to the control substrate 12. The springs (contacting portion biasing means) 112 are compression coil springs inserted into the hollow insides of the barrels 111 to bias the plungers 110 toward the cathode current collectors 40 and anode current collectors 41. Accordingly, the terminals 11 can be in contact with the cathode current collectors 40 and anode current collectors 41 to electrically connect the fuel cell module 3 and the control substrate 12.

As shown in FIG. 3, the terminal 11a is in contact with a contact portion 401b of a cathode current collector 40b of a power unit 4b, the terminal 11b is in contact with a contact portion 411a of an anode current collector 41a of a power unit 4a, the terminal 11c is in contact with a contact portion 411b of an anode current collector 41b of the power unit 4b, and the terminal 11d is in contact with a contact portion 401a of a cathode current collector 40a of the power unit 4a. As shown in FIG. 1, a wiring (connecting portion, not shown) for electrically connecting the terminals 11a, 11b, and a wiring (not shown) for electrically connecting each of the terminals 11c, 11d to the USB connector 14, are printed on an after-mentioned control substrate 12. Accordingly, MEAs 42a, 42b (see FIG. 4) of the power units 4a, 4b are connected in series.

The control substrate 12 is, for example, an electronic part for increasing or decreasing an output voltage of the fuel cell module 3. This control substrate 12 can control outputs of the power units 4 in accordance with a rated output of electronic equipment (not shown). The control substrate 12 is fixed inside the body 10. The terminals 1, the electric double layer capacitor 13, and the USB connector 14 are connected onto the control substrate 12. The control substrate 12 operates by power supply from the fuel cell module 3.

The electric double layer capacitor 13 is connected to the control substrate 12, and charged by electric power from the fuel cell module 3. For example, the electric double layer capacitor 13 is charged by predetermined electric power in advance. When an output of electric power of the fuel cell module 3 is unstable, such as when power generation begins, the electric double layer capacitor 13 can supply power to electronic equipment (not shown) preferentially, and can be charged by excess power. The electric double layer capacitor 13 is fixed inside the body 10.

The USB connector 14 is connected to the control substrate 12. Electric power from the fuel cell module 3 and electric double layer capacitor 13 is outputted from the USB connector 14 to electronic equipment (not shown) via a bus power line provided to a USB cable (not shown). The USB connector 14 is a receptacle.

Methanol aqueous solution (liquid fuel) which is a fuel for the fuel cell module 3 is stored in the fuel cartridge 15. The fuel cartridge 15 is detachably mounted on the body 10. The fuel cartridge 15 is filled with methanol aqueous solution having a concentration of methanol (fuel component) of, e.g., ten weight percent and with propellant gas. The methanol aqueous solution is supplied to the fuel cell module 3 via a tube 150.

The detachment preventing means 16 is mounted on the body 10 to prevent the detachment of the fuel cell module 3 mounted inside the body 10. As the detachment prevent means 16, triangular clasps are mounted on two corners facing each other in portions where the fuel cell module 3 is mounted on the body 10. The fuel cell module 3 is held between the detachment preventing means 16 and a bottom surface (not shown) of the body 10.

[Structure of the Fuel Cell Module]

The fuel cell module 3 generates electric power by use of oxygen in the air and methanol aqueous solution supplied from the fuel cartridge 15. As shown in FIG. 3, the fuel cell module 3 includes the power units 4a, 4b, a fuel tank 5, and a case 6. The power unit 4a, the fuel tank 5, and the power unit 4b are superimposed sequentially in the case 6. The fuel cell module 3 does not use accessories such as a pump, a fan, and a blower. The fuel cell module 3 is a passive (open) fuel cell using natural divergence of, e.g., methanol aqueous solution and the air.

As shown in FIG. 4, the power units 4 (4a, 4b) generate electrical power by use of oxygen in the air flowing from the air flow holes 63 provided to the surface of the case 6 (upper end plate 60, lower end plate 61) and methanol aqueous solution supplied from the fuel tank 5. As shown in FIG. 5, the power units 4 include the cathode current collectors 40, the anode current collectors 41, the MEAs 42, and seal members 43.

The cathode current collectors 40 (40a, 40b) are plates provided adjacent air electrodes 420 of the MEAs 42. The anode current collectors 41 (41a, 41b) are plates provided adjacent fuel electrodes 421 of the MEAs 42. The cathode current collectors 40 and anode current collectors 41 are made of a conductive and corrosion-resistant material (for example, a metal such as titanium), and sandwich the MEAs 42. The cathode current collectors 40 and anode current collectors 41 are provided to derive electrical power efficiently in accordance with potential difference generated in the MEAs 42.

As shown in FIG. 4, each of the cathode current collectors 40 and anode current collectors 41 has a plane quadrilateral shape whose four corners are chamfered. Each of the cathode current collectors 40 has a plurality of flow holes 402. Each of the anode current collectors 41 has a plurality of flow holes 412. The air supplied to the MEAs 42 and steam (water) generated at the MEAs 42 by power generation flow through the flow holes 402 of the cathode current collectors 40. Methanol aqueous solution supplied to the MEAs 42 and carbon dioxide (gas) generated at the MEAs 42 by power generation flow through the flow holes 412 of the anode current collectors 41.

Each of projecting portions 400 projects from a part of each the cathode current collectors 40 toward the side surface 31 of the case 6 (lower end plate 61). Each of projecting portions 410 projects from a part of each the anode current collectors 41 toward the side surface 31 of the case 6 (lower end plate 61). Top ends of the projecting portions 400 (400a, 400b), 410 (410a, 410b) are bended to have L-shaped cross sections so that the top ends are respectively in contact with the openings 62 (62d, 62b, 62c, 62a). The portions (contact portions 401, 411) facing the openings 62 of the projecting portions 400, 410 are open from the openings 62 to the outside of the case 6 along surfaces of the MEAs 42. The terminals 11 of the cell holder 1 can be mounted along the surfaces of the MEAs 42, along which surfaces the contact portions 401, 411 are open. Accordingly, the cell holder 1 can be thinned in comparison to the case where contact portions (not shown) are open in the thickness direction of the MEAs 42 and the terminals 11 are placed on the fuel cell module 3.

All the openings 62 are formed on one side surface 31, and the contact portions 401, 411 are open in the same direction. The contact portions 401, 411 are open in the same direction, so that the terminals 11 of the cell holder 1 can be arranged facing one side surface 31. The projecting portions 400, 410 are formed to have L-shapes. The contact portions 401, 411 are coincident in position with each other in the thickness direction of the MEAs 42 when viewed perpendicularly to the side surface 31. Accordingly, the terminals 11 of the cell holder 1 can be arranged in line horizontally.

The contact portions 401a, 411a in the plane view do not overlap with each other. The contact portions 401a, 411a are formed asymmetrically with respect to a symmetry axis A (see FIG. 3) of a plane shape of the power units 4 except the projecting portions 400, 410. The cathode current collector 40b and anode current collector 41b are respectively inverted in shape and position relative to the cathode current collector 40a and anode current collector 41a with respect to the symmetry axis A. At this time, since the contact portions 401a, 411a are formed asymmetrically with respect to the symmetry axis A, the contact portions 401a, 411a and the contact portions 401b, 411b in the plane view are positioned not to overlap with each other. As described above, since the contact portions 401a, 411a in the plane view do not overlap with each other, and are formed asymmetrically with respect to the symmetry axis A, the two power units 4a, 4b can have the same shape as each other. Accordingly, the production process of the fuel cell module 3 can be simplified. The two power units 4a, 4b are positioned inversely with respect to the symmetry axis A across the fuel tank 5. The contact portions 401, 411 are shifted laterally when viewed perpendicularly to the side surface 31 to prevent the terminals 11 of the cell holder 1 from being arranged vertically. As a result, the cell holder 1 can be thinned.

Insulating portions 403, 413 (see FIG. 5) for insulating the cathode current collectors 40 and anode current collectors 41 are provided between the cathode current collectors 40 and anode current collectors 41 and the case 6. The insulating portions 403, 413 are, e.g., films made of resin.

The MEAs 42 (42a, 42b) generate electrical power by use of air and methanol aqueous solution supplied from the flow holes 402 of the cathode current collectors 40 and the flow holes 412 of the anode current collectors 41. As shown in FIG. 5, the MEAs 42 include air electrodes 420, fuel electrodes 421, and electrolyte membranes 422. The electrolyte membranes 422 are structured of, e.g., perfluorosulphonic acid based monovalent cation exchange membranes. The electrolyte membranes 422 in the plane view have a quadrilateral plate shape whose four corners are chamfered. The air electrodes 420 and fuel electrodes 421 are structured of, e.g., carbon papers holding catalysts such as platinum. The fuel electrodes 421 are formed on surfaces of the electrolyte membranes 422, on the surfaces facing the fuel tank 5. The air electrodes 420 are formed on outer surfaces of the electrolyte membranes 422 (the outer surfaces facing away from the fuel electrodes 421).

The seal members 43 are positioned between edge portions of the electrolyte membranes 422 and the cathode current collectors 40 and between the edge portions of the electrolyte membranes 422 and the anode current collectors 41. The seal members 43 are formed of an elastic material (such as polytetrafluoro-ethylene and SBR). The seal members 43 are sandwiched between the electrolyte membranes 422 and cathode current collectors 40 and between the electrolyte membranes 422 and anode current collectors 41. The seal members 43 are elastically deformed to seal peripheries of the air electrodes 420 and fuel electrodes 421.

The seal members 43 may have adhesion layers (not shown) adhering to the members (the electrolyte membranes 422 and cathode current collectors 40, and the electrolyte membranes 422 and anode current collectors 41) in contact with surfaces of the seal members 43. Such adhesion layers make sealing ability of the seal members 43 higher.

The seal members 43 prevent, e.g., steam generated at the air electrodes 420 and methanol aqueous solution from flowing out of the MEAs 42. Since the outflow of, e.g., steam is prevented, the fuel cell module 3 can be contained in the cell holder 1 (see FIG. 1) without considering influence of, e.g., steam on the control substrate 12 (electronic component) and electric double layer capacitor 13 (see FIG. 1).

Methanol aqueous solution from the fuel cartridge 15 (see FIG. 1) is temporarily stored in the fuel tank 5. The fuel tank 5 supplies methanol aqueous solution to the fuel electrodes 421. The fuel tank 5 has a frame shape, in which methanol aqueous solution flows, and has a fuel flow path 51 in which the methanol aqueous solution is temporarily stored. The fuel tank 5 has a fuel supply pipe 52 and carbon dioxide discharging pipe 53.

The fuel supply pipe 52 is a pipe for making methanol aqueous solution from the fuel cartridge 15 (see FIG. 1) flow into the fuel flow path 51. A top end of the fuel supply pipe 52 projects outwardly from the case 6, and the other top end is connected to the fuel flow path 51. When the fuel cell module 3 is mounted on the cell holder 1, the tube 150 (see FIG. 1) is attached to the top end of the fuel supply pipe 52. Methanol aqueous solution is supplied from the fuel cartridge 15 to the fuel flow path 51 via the tube 150. The fuel tank 5 is superimposed on the fuel electrodes 421 across the anode current collectors 41. The methanol aqueous solution in the fuel flow path 51 is supplied to the fuel electrodes 421 through the flow holes 412 (see FIG. 4).

The carbon dioxide discharging pipe 53 is a pipe for discharging carbon dioxide in the fuel flow path 51 to the outside. A top end of the carbon dioxide discharging pipe 53 projects outwardly from the case 6, and the other top end is connected to the fuel flow path 51. A carbon dioxide separation membrane (not shown) is provided to the fuel flow path 51. Carbon dioxide generated by power generation is separated from the methanol aqueous solution, and discharged from the carbon dioxide discharging pipe 53 to the outside.

The case 6 contains and protects the power units 4a, 4b and fuel tank 5 integrated with each other. As shown in FIG. 4, the case 6 is a box body including the upper end plate 60, the lower end plate 61, and the screws 64. The upper end plate 60 and lower end plate 61 are combined with each other to form a space in the case 6. The upper end plate 60 and lower end plate 61 are fixed by screwing the screws 64 into the screw holes 65 to be combined with each other. Then, the power units 4a, 4b can make intimate contact with, and be integrated with the fuel tank 5.

The openings 62 corresponding to the number of the cathode current collectors 40 and anode current collectors 41 are formed on the side surface 31 of the lower end plate 61. A plurality of the air flow holes 63 are formed on the top surface of the upper end plate 60 and the bottom surface of the lower end plate 61.

Not like conventional fuel cells, since the cell holder 1 and fuel cell module 3 are structured as described above, a conductive material does not need to be used to electrically connect the current collectors of a plurality of the power units 4 to each other in the fuel cell module 3. By mounting the fuel cell module 3 to the cell holder 1, the electrical connection between the cell holder 1 and fuel cell module 3 and the serial connection between the power units 4 in the fuel cell module 3 are achieved at the same time.

The anodes in the claims correspond to the anode current collectors 41 and fuel electrodes 421 in this embodiment. The cathodes in the claims correspond to the cathode current collectors 40 and air electrodes 420 in this embodiment.

[Mounting of the Fuel Cell Module to the Cell Holder]

The mounting of the fuel cell module 3 to the cell holder 1 is explained below in reference to FIG. 1.

First, the terminals 11 of the cell holder 1 are aligned to the corresponding openings 62 of the fuel cell module 3. The fuel cell module 3 is pressed into the body 10 in the state where the plungers 110 of the terminals 11 are pressed into the barrels 111. At this time, the plungers 110 of the terminals 11 are biased by the springs 112 and inserted from the corresponding openings 62 into the fuel cell module 3. The plungers 110 are pressed against the contact portions 401 of the cathode current collectors 40 and the contact portions 411 of the anode current collectors 41 (see FIG. 3). Accordingly, the terminals 11 can be electrically connected to the cathode current collectors 40 and anode current collectors 41.

The wiring (not shown) for electrically connecting the terminals 11a and 11b, and the wiring (not shown) for electrically connecting each of the terminals 11c,11d to the USB connector 14 are printed on the control substrate 12. Thus, the MEAs 42a, 42b (see FIG. 3) are connected to each other in series.

The tube 150 of the fuel cartridge 15 is mounted on the fuel supply pipe 52. The detachment preventing means 16 is mounted on the body 10 to fix the fuel cell module to the cell holder 1.

[Operation of the Cell Holder and Fuel Cell Module]

The operation of the cell holder I and fuel cell module 3 is explained below in reference to FIGS. 1 to 4.

Methanol aqueous solution is supplied from the fuel cartridge 15 to the fuel cell module 3 through the tube 150. This methanol aqueous solution flows from the fuel supply pipe 52 into the fuel flow path 51 of the fuel tank 5. Then, the methanol aqueous solution comes in contact with the fuel electrodes 421 (see FIG. 5) of the MEAs 42 through the flow holes 412 of the anode current collectors 41. At the same time, air flows through the air flow holes 63 of the upper end plate 60 and lower end plate 61 and through the flow holes 402 of the cathode current collectors 40, and comes in contact with the air electrodes 420 (see FIG. 5) of the MEAs 42.

When methanol aqueous solution comes in contact with the fuel electrodes 421 and air (oxygen) comes in contact with the air electrodes 420, the USB connector 14 of the cell holder 1 is electrically connected to electronic equipment (load). At the fuel electrodes 421 and air electrodes 420 of the MEAs 42, methanol, water, and oxygen are electrochemically reacted as shown in the following equations (1) and (2). Then, power is generated.
Fuel electrodes 421: CH₃OH+H₂O→CO₂+6H⁺+6e⁻ (1)
Air electrodes 420: O₂+4H⁺+4e⁻→2H₂O (2)

Electricity is derived via the cathode current collectors 40 and anode current collectors 41, and supplied to the electronic equipment (not shown) via the USB connector 14 and a USB cable (not shown).

Carbon dioxide (CO₂) generated at the fuel electrodes 421 becomes bubbles in methanol aqueous solution in the fuel flow path 51 of the fuel tank 5, and is discharged to the outside via a carbon dioxide separation membrane (not shown) and the carbon dioxide discharging pipe 53.

The preferred embodiments of the present invention have been explained above. The present invention is not limited to the above embodiments. Without departing from the scope of the invention, the following alternatives are possible.

For example, a wiring (cathode connecting portion, not shown) for electrically connecting the terminals 11a and 11d, and for connecting the terminals 11a, 11d to the USB connector 14, and a wiring (anode connecting portion, not shown) for electrically connecting the terminals 11b, 11c, and for connecting the terminals 11b, 11c to the USB connector 14 may be printed on the control substrate 12 of the cell holder. Accordingly, the MEAs 42a, 42b (see FIG. 4) of the power units 4a, 4b may be connected in parallel in the cell holder 1.

As described above, all the openings 62 of the fuel cell module 3 are formed on the side surface 31, and the contact portions 401 of the cathode current collectors 40 and the contact portions 411 of the anode current collectors 41 are open in the same direction. Contact portions (not shown) of the fuel cell module 3 of the present invention may be open in the different directions along the surfaces of the MEAs 42. In this case, terminals (not shown) of the cell holder 1 are formed in positions corresponding to the contact portions.

The contact portions 401, 411 may be exposed to the outer surface of the side surface 31. In this case, the contact portions 401, 411 can be open along the surfaces of the MEAs 42, and the terminals 11 of the cell holder 1 can be placed along the surfaces of the MEAs 42.

When the power units 4 in the plane view have a square shape, a diagonal line (not shown) of the square may be the symmetry axis of the power units 4.

As described above, the case 6 covers the power units 4a, 4b and the fuel tank 5. The case 6 may enable a plurality of the power units 4 to be integrated with each other. For example, the case may be formed of a lower end plate (not shown) having a substantially U-shape in the side view and an upper end plate (not shown) mounted on an upper portion of the lower end plate, so that it is a case whose side facing the terminals 11 of the cell holder 1 is fully open.

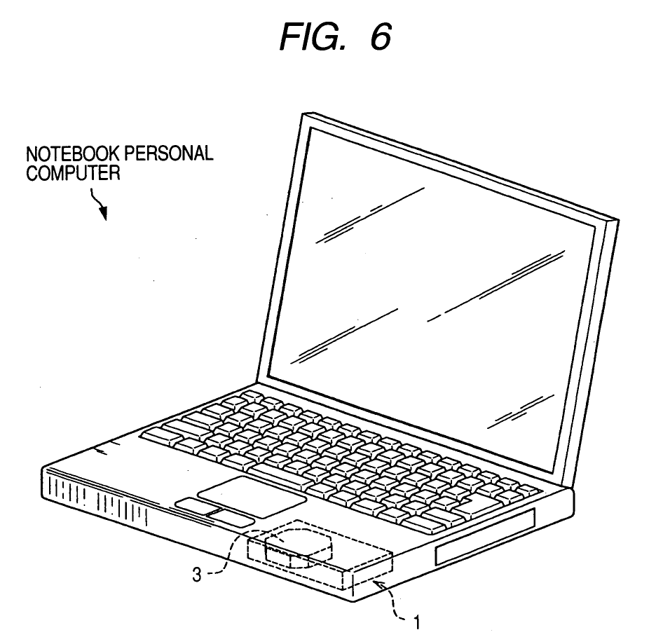

The cell holder 1 of the present invention may supply electrical power of the fuel cell module 3 mounted inside the cell holder 1 to electronic equipment (not shown) via a USB cable (not shown) connected to the USB connector 14 (see FIG. 1) from the outside. Namely, the fuel cell module 3 may be a bus power supply unit. As shown in FIG. 6, a cell holder 1 is mounted inside a notebook personal computer (electronic equipment). The fuel cell module 3 is mounted on the cell holder 1, so that the cell holder 1 may supply electrical power of the fuel cell module 3 to the notebook personal computer. FIG. 6 is an overall perspective view of a notebook personal computer having a cell holder of an alternative of this embodiment. Electronic equipment having the cell holder 1 of the present invention is not limited to a notebook personal computer. For example, the electronic equipment may be a mobile phone and a PDA (Personal Digital Assistant).

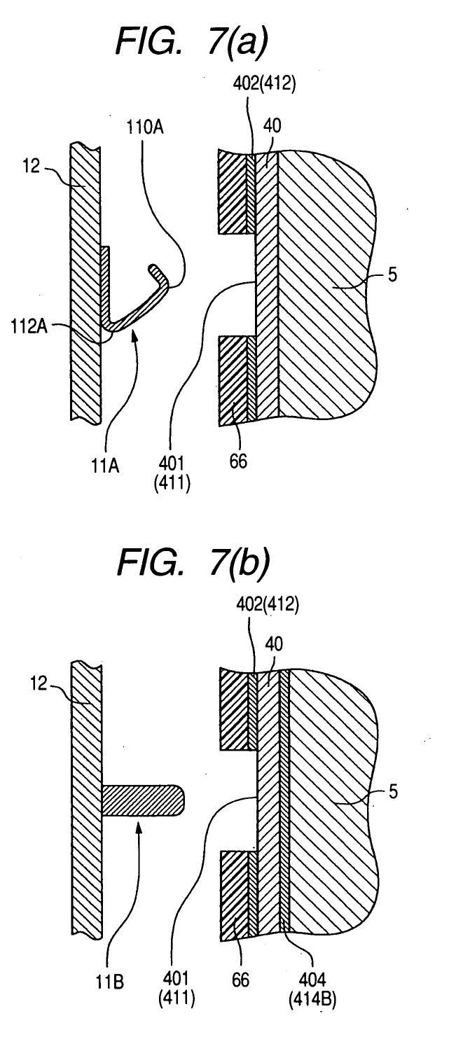

As described above, the terminals 11 of the cell holder 1 are spring probes. As shown in FIG. 7A, terminals 11A may be, e.g., plate springs formed of a conductive and flexible material such as stainless steel. Contacting portions 110A to be in contact with the contact portions 401, 411 may be formed on top end portions of the terminals 11A. Biasing portions 112A (contacting portion biasing means) for biasing the contacting portions 110A toward the contact portions 401, 411 when the material bends, may be formed on the terminals 11A. Accordingly, the terminals 11A can be in electrical communication with the contact portions 401, 411 reliably.

As shown in FIG. 7B, terminals 11B having conductivity may come in contact with the contact portions 401, 411. Elastic portions (contact portion biasing means) 404B, 414B formed of an elastic material such as rubber may be provided to rear surfaces of the contact portions 401, 411. Accordingly, the elastic portions 404B, 414B may bias the contact portions 401, 411 toward terminals 11B. FIGS. 7A, 7B are explanatory views for explaining another embodiment of the terminals of the cell holder and the fuel cell module of an alternative of this embodiment. FIG. 7A is a schematic view for schematically showing another embodiment of the terminals of the cell holder. FIG. 7B is a schematic view for schematically showing a part of the fuel cell module in which the elastic portions are provided to the rear surfaces of the contact portions.

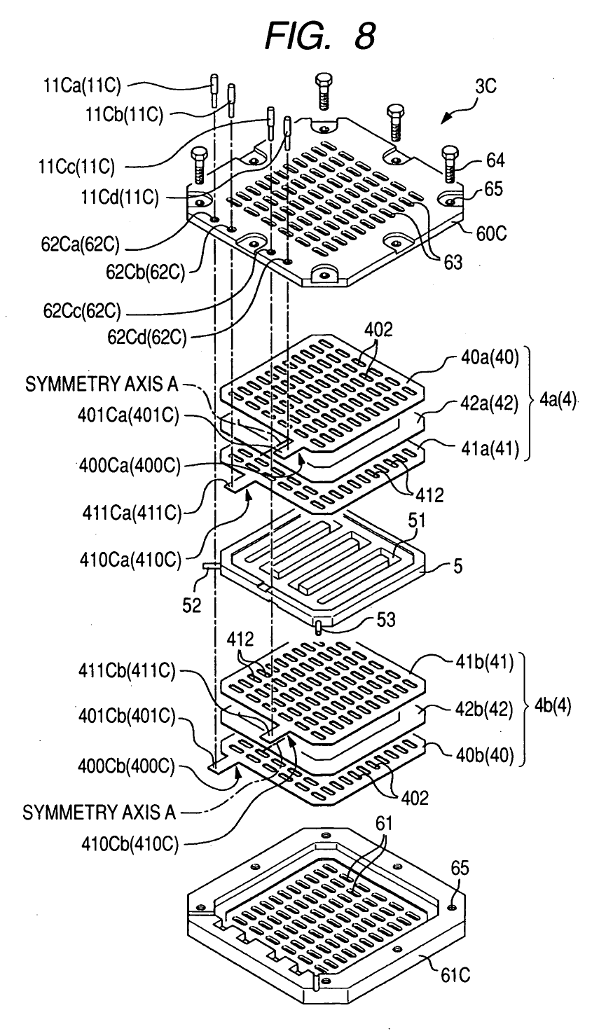

As shown in FIG. 8, terminals 11C may be inserted into the openings 62 from above a fuel cell module 3C to come in contact with contact portions 401C, 411C. FIG. 8 is an exploded perspective view showing another embodiment of the fuel cell module of an alternative of this embodiment. At this time, the terminals 11 of the cell holder 1 (see FIG. 1) may be provided to a lid (not shown) covering the body 10 (see FIG. 1) from above the body 10. Openings 62C may be formed on a top surface of an upper end plate 60C of the fuel cell module 3. The contact portions 401C, 411C, which are open from the openings 62C upwardly to the outside, may be provided to top surfaces of projecting portions 400C, 410C.

Contact portions 401Ca, 411Ca do not overlap with each other in the plane view. The contact portions 401Ca, 411Ca are respectively formed asymmetrically with respect to the symmetry axis A of a plane shape of the power units 4 excluding the projecting portions 400C, 410C. Accordingly, the two power units 4a, 4b can have the same shape, and a simple production process can be achieved. Additionally, the two power units 4a, 4b are placed on both sides of the fuel tank 5 inversely with respect to the symmetry axis A. Accordingly, the contact portions 401C, 411C can be arranged not to overlap with each other in the plane view.

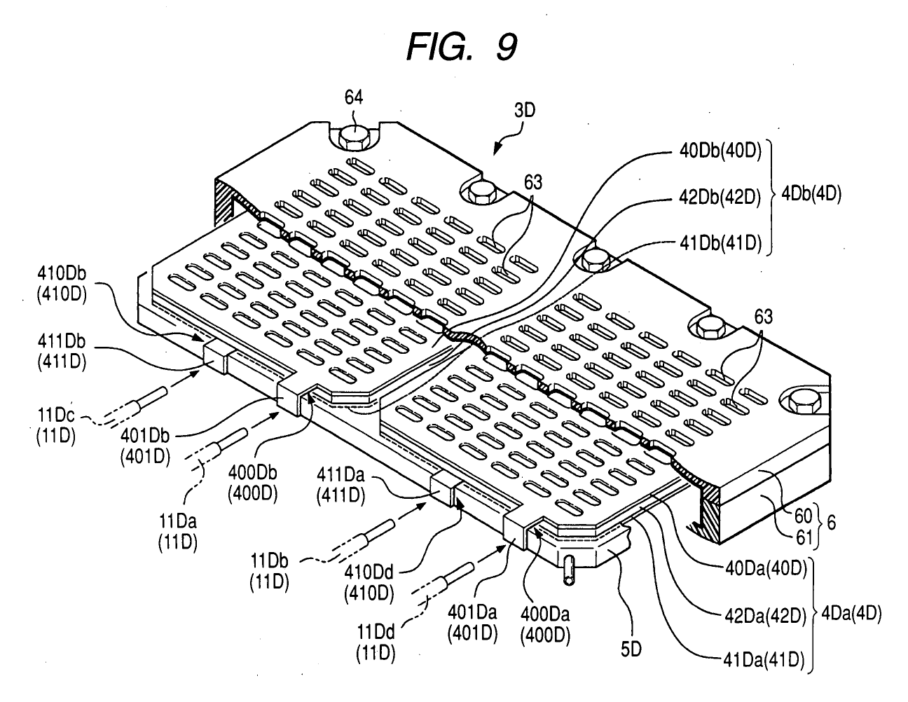

As described above, the case where the fuel cell module 3 includes the power units 4a, 4b between which the fuel tank 5 is sandwiched, has been explained. For example, as shown in FIG. 9, a fuel cell module 3D may include a plurality of power units 4Da, 4Db on one side of a fuel tank 5D. FIG. 9 is an exploded perspective view of the fuel cell module of an alternative of this embodiment.

The power units 4Da, 4Db are placed laterally in parallel. Anode current collectors 41Da, 41Db, MEAs 42Da, 42Db, and cathode current collectors 40Da, 40Db are superimposed on the fuel tank 5 sequentially. A fuel flow path (not shown) is open from only the top surface of the tank 5. Projecting portions 400D of the cathode current collectors 40D and projecting portions 410D of the anode current collectors 41D are formed facing one side surface (not shown) of the case 6. Top ends of the projecting portions 400D, 410D are bended to have an L-shape for being in contact with an inner wall of this side surface. Openings (not shown) which are cylindrical holes are formed in portions of the lower end plate 61, the portions being in contact with the projecting portions 400D, 410D (contact portions 401, 411). All the contact portions 401, 411 are open from the openings to the outside in the direction perpendicular to this side surface. Terminals 11Dd, 11Db, 11Da, 11Dc of the cell holder (not shown) are pressed against contact portions 40Da, 401Db, 411Da, 411Db from the outside. A wiring (not shown) for electrically connecting the terminals 11D to each other and to the USB connector (not shown) in accordance with the above predetermined combination is printed on a control substrate (not shown). Accordingly, the MEAs 42Da, 42Db can be electrically connected to each other in series or in parallel.

In the fuel cell modules 3 shown in FIG. 3, the two power units 4 share one fuel tank 5. In the fuel cell module 3D shown in FIG. 9, the two power units 4D share one fuel tank 5D. Each of power units (not shown) may have one fuel unit (not shown).

As described above, the anode current collectors 41 are provided adjacent the fuel electrodes 421, the cathode current collectors 40 are provided adjacent the air electrodes 420, and the contact portions 401, 411 are respectively provided to the cathode current collectors 40 and anode current collectors 41. In the fuel cell module of the present invention, an anode and a cathode (not shown) formed of a porous material holding a catalyst having sufficient conductivity, corrosion resistance, and strength, such as platinum, are respectively provided to both surfaces of an electrolyte membrane (not shown) to form an MEA (not shown). Contact portions may be provided to the anode and cathode.

What is claimed is:

1. A cell holder, on which a fuel cell module is mounted, the fuel cell module including a plurality of power units which have membrane electrode assemblies generating electrical power by use of a liquid fuel, a case for integrating the plurality of the power units with each other, and contact portions each of which is at least a part of each of anodes and cathodes of all the power units, the contact portions being used for electrical connection from outside the case for integrating the plurality of the power units with each other, the cell holder comprising:
terminals corresponding to a number of the anodes and the cathodes of the power units, the terminals being electrically connected to the contact portions when the fuel cell module is mounted on the cell holder; and
a connecting portion for electrically connecting the terminals respectively corresponding to a contact portion of an anode of one of the power units and to a contact portion of a cathode of another of the power units.

2. A cell holder, on which a fuel cell module is mounted, the fuel cell module including a plurality of power units which have membrane electrode assemblies generating electrical power by use of a liquid fuel, a case for integrating the plurality of the power units with each other, and contact portions each of which is at least a part of each of anodes and cathodes of all the power units, the contact portions being used for electrical connection from outside the case for integrating the plurality of the power units with each other, the cell holder comprising:
terminals corresponding to a number of the anodes and the cathodes of the power units, the terminals being electrically connected to the contact portions when the fuel cell module is mounted on the cell holder;
an anode terminal connecting portion for electrically connecting the terminals corresponding to the contact portions of the anodes of the plurality of the power units to each other; and
a cathode terminal connecting portion for electrically connecting the terminals corresponding to the contact portions of the cathodes of the plurality of the power units to each other.

3. A cell holder according to claim 1, wherein the terminals include contacting portions in contact with the contact portions and contacting portion biasing means for biasing the contacting portions toward the contact portions.

4. A fuel cell module, which is mounted on the cell holder according to claim 1 and electrically connected to the terminals of the cell holder, the fuel cell module comprising:
a plurality of power units having membrane electrode assemblies generating electrical power by use of a liquid fuel; and
a case for integrating the plurality of the power units with each other,
wherein an anode and a cathode of each of the plurality of the power units have contact portions which are in contact with and electrically connected to the terminals when the fuel cell module is mounted on the cell holder.

5. A fuel cell module, which is mounted on the cell holder according to claim 1 and electrically connected to the terminals of the cell holder, the fuel cell module comprising:
a plurality of power units having membrane electrode assemblies generating electrical power by use of liquid fuel; and
a case for integrating the plurality of the power units with each other,
wherein an anode and a cathode of each-of the plurality of the power units have contact portions which are in contact with and electrically connected to the terminals when the fuel cell module is mounted on the cell holder, and contact portion biasing means for biasing the contact portions toward the terminals corresponding to the contact portions.

6. A fuel cell module according to claim 4, wherein the contact portions are open along surfaces of the membrane electrode assemblies.

7. A fuel cell module according to claim 4, wherein the contact portions of a pair of the anode and the cathode do not overlap with each other in a plane view, and are formed asymmetrically with respect to a symmetry axis of the power units.

8. Electronic equipment comprising the cell holder according to claim 1 and the fuel cell module according to claim 4.
